(19) United States
(12) Patent Application Publication
(10) Pub. No.: US 2024/0099201 A1
(43) Pub. Date: Mar. 28, 2024

(54) Biodegradable Plant Container with Tear Strips

(71) Applicant: Green IP, LLC, Green Cove Springs, FL (US)

(72) Inventors: Robert Neal Alfred Hawkinson, Green Cove Springs, FL (US); Kelvin T. Okamoto, Carmel, IN (US)

(21) Appl. No.: 18/462,549

(22) Filed: Sep. 7, 2023

Related U.S. Application Data
(60) Provisional application No. 63/409,329, filed on Sep. 23, 2022.

(51) Int. Cl. A01G 9/029

(52) U.S. Cl. CPC A01G 9/0291

(57) ABSTRACT

A biodegradable plant container has side tear strips extending from its top opening to its bottom. The tear strips are hinged near the bottom and fan out to establish a diameter for a planting hole. The inside surface of the tear strips as root slicers that tease the roots of a root ball in the plant container when the tear strips are pulled outward and fanned out. The fanned out tear strips establish the diameter for the planting hole. The plant container also has a depth index to establish the proper planting depth. Once the tear strips have been opened and fanned out, the biodegradable plant container is planted directly in the soil where it will degrade.

### FIELD OF THE INVENTION

This invention relates to a biodegradable plant container that can be placed directly in a planting hole without the need to remove the plant and root ball from the container.

### BACKGROUND OF THE INVENTION

Conventional plant containers are not biodegradable. Consequently, in order to plant a plant from a conventional plastic plant container, the user must first remove the plant and root ball from the plastic plant container by pulling on the plant and at the same time depressing the bottom of the plastic container in order to release the root ball from the container. Such a procedure is not only difficult, but has the potential of damaging the upper part of the plant.

Second, the user needs to tease the exposed roots or otherwise rough up the root ball in order to allow the roots in the root ball to spread more rapidly to the surrounding soil. Teasing the roots when the root ball is unsupported by any structure runs the risk of losing substantial portions of the potting soil making up the root ball.

Third the user must dig a planting hole that is four times the diameter of the container in order to enhance the spread of the roots once the plant is in place. Moreover, the planting hole must be dug to the proper depth that is not too shallow thereby exposing unnecessary parts of the root ball or not too deep thereby tending to smother the roots of the plant.

Consequently, there is a need for a biodegradable plant container that can be placed directly in the planting hole with the root ball still in the plant container. Further there is a need for a biodegradable plant container that can provide indices for the proper diameter and depth of the planting hole. In addition, there is a need for a plant container that can tease the roots of the root ball while providing continuing support for the root ball when the biodegradable plant container is readied for planting.

### SUMMARY OF THE INVENTION

A biodegradable plant container with side tear strips of the present invention overcomes the problems associated with conventional plastic plant containers. First, the plant container of the present invention is formed of biodegradable material that, when covered with soil, will break down 90% in soil in approximately 90 days. That means that the biodegradable plant container of the present invention can be planted in place in the ground along with the plant and its root ball

Second, the plant container of the present invention has at least two side tear strips and typically between three and four tear strips. The side tear strips extend along the side wall of the plant container from the top of the plant container to the bottom of the plant container. The tear strips are outlined by perforated lines that allow easy separation of the tear strips from the remaining portion of the side wall of the plant container. A plastic hinge attaches the bottom of the tear strips to the bottom of the plant container so that the tear strips can spread out like the petals of a flower. Once the tear strips have been fully spread, they establish the proper diameter for the planting hole. Further, the biodegradable plant container has an index mark near its top in order to establish the proper planting depth for the plant and root ball.

The inside surface of the tear strips has root slicers that extend into the interior of the biodegradable plant container. As plants grow in the biodegradable plant container, the roots of the plant necessarily surround and engage the root slicers on the inside of the tear strips. As the tear strips are pulled away from the plant container prior to planting, the roots slicers cut, pull, and break the roots near the outside of the root ball.

The biodegradable material of the plant container can also be impregnated with beneficial microbes, fertilizers, pesticides or other chemicals to enhance the soil environment for the plant.

In another aspect of the present invention, the plant container can be made of standard nonbiodegradable plastic. Tear strips as previously described have root slicers on the inside surface. When the tear strips are pulled open from the top, the root slicers tease the roots while the remaining portions of the plant container support the root ball from disintegration while the plant and the root ball are removed from the nonbiodegradable container.

Further objects, features and advantages will become apparent upon consideration of the following detailed description of the invention when taken in conjunction with the drawings and the appended claims.

### BRIEF DESCRIPTION OF THE DRAWINGS

FIG. 1 is a front elevation view of an empty biodegradable plant container with tear strips in accordance with the present invention.

FIG. 2 is a top plan view of the empty biodegradable plant container with the tear strips in accordance with the present invention.

FIG. 3 is a front elevation view of the biodegradable plant container with the tear strips opened, filled with potting soil, supporting a plant, and positioned in a planting hole in accordance with the present invention.

FIG. 4 is a bottom plan view of the biodegradable plant container with the tear strips opened in accordance with the present invention.

### DETAILED DESCRIPTION OF THE PREFERRED EMBODIMENT

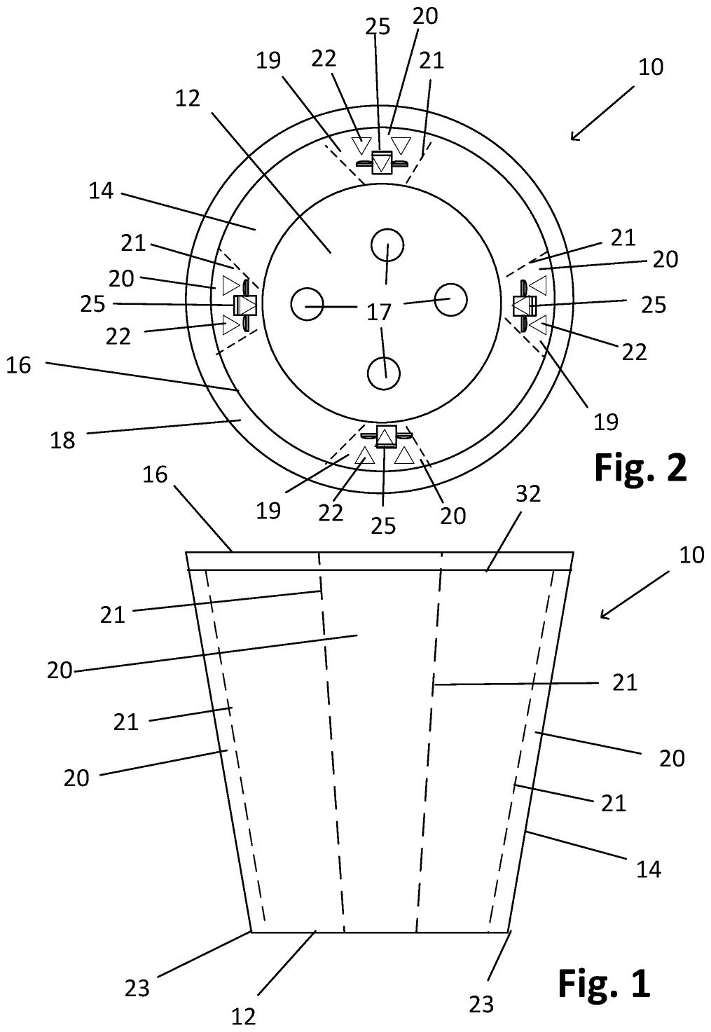

FIGS. 1 and 2 show an empty biodegradable plant container 10 in accordance with the present invention. The plant container 10 has a bottom 12, a top opening 16, and a side wall 14 extending around the diameter of the plant container 10 between the top opening 16 and the bottom 12. The plant container 10 has a top edge 18 surrounding the top opening 16. While the plant container 10 of the present invention is illustrated as having a round bottom 12 and a round top opening 16, the plant container 10 could be of any geometric shape. The bottom 12 has drainage holes 17.

The plant container 10 is constructed of a biodegradable plastic. The formulation of the plastic material for the biodegradable plant container 10 is a biodegradable aliphatic polyester produced primarily from diacid and diol monomers, described in detail in U.S. Patent Publication No. 2019/0375932, published Dec. 12, 2019, which is incorporated herein by reference in its entirety. Further, the material for the plant container 10 can be impregnated with beneficial microbes, fertilizers, pesticides, or other chemicals to enhance the soil environment for the plant 34.

If the biodegradable plant container 10 of the present invention is surrounded by soil in a planting hole 30 in the ground 28, the biodegradable plant container 10 will break down 90% in approximately 90 days.

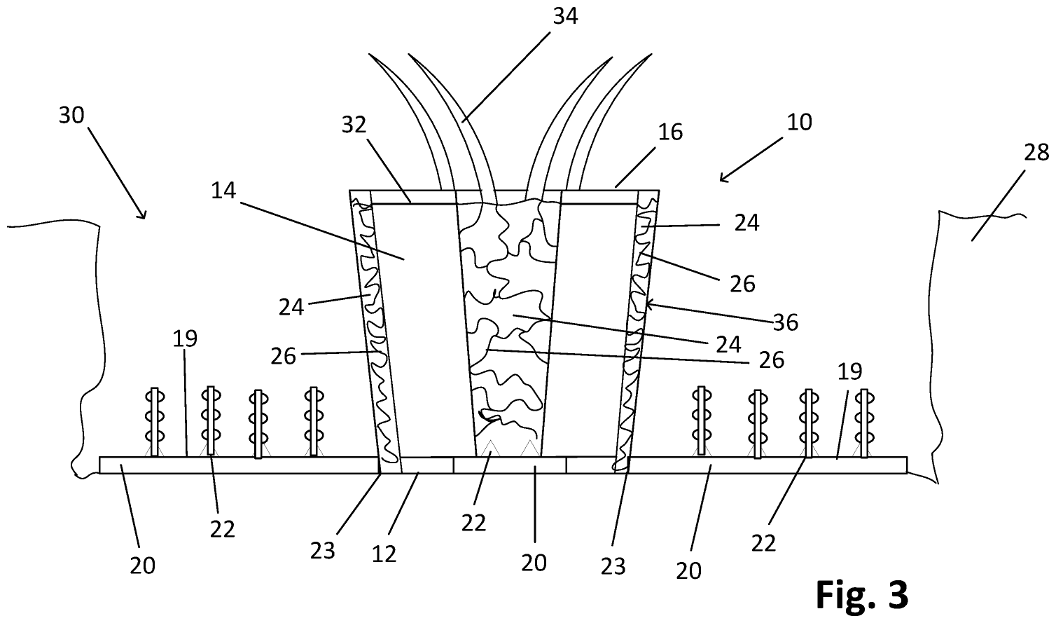

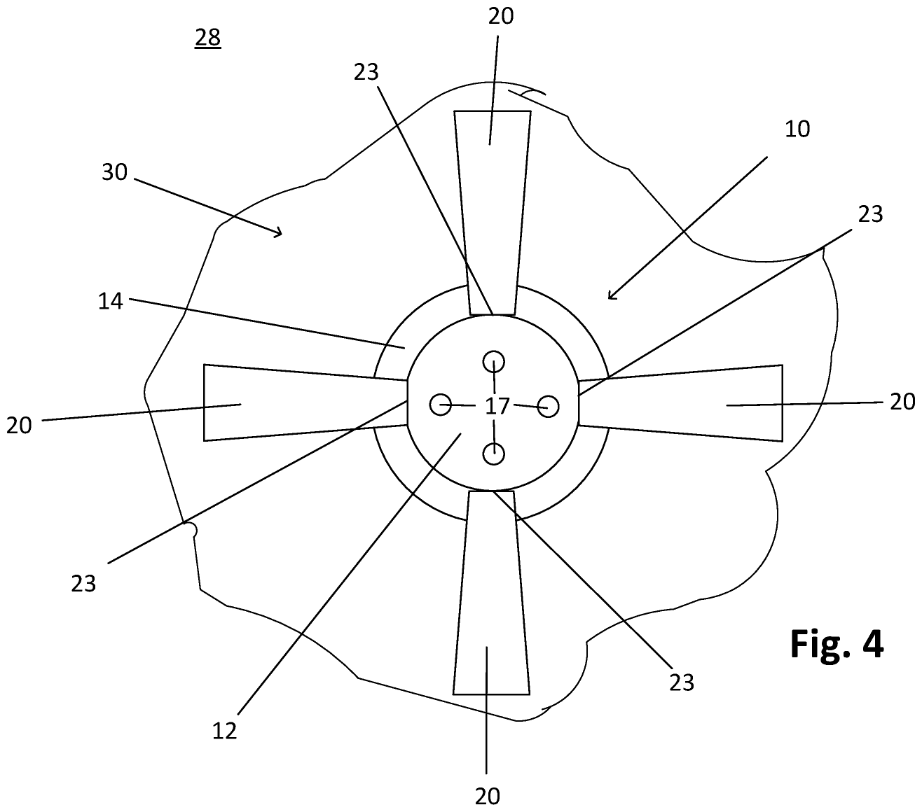

The illustrated plant container 10 has four tear strips 20 outlined by perforated tear lines 21. While the plant container 10 described has four tear strips 20, the plant container 10 of the present invention could have at least two tear strips but could have any number of tear strips 20. The tear strips 20 extend from the top opening 16 of the container 10 to the bottom 12 of the container 10. An integral plastic hinge 23 is located at the bottom of each tear strip 20 and connects the bottom 12 of the plant container 10 to each of the tear strips 20. The perforated tear lines 21 and the plastic hinges 23 allow the user to detach the tear strips 20 from the rest of the side wall 14 and to unfold the tear strips 20 out as shown in FIGS. 3 and 4.

As shown in FIGS. 3 and 4, the spread tear strips 20 establish a diameter for a planting hole 30 in the ground 28 for the plant container 10 with the plant 34. In addition, the container has a depth index 32 that establishes the proper depth of the planting hole 30 for the plant container 10 with the plant 34.

With reference to FIGS. 3, the plant container 10 contains the plant 34 with a root ball 36. The root ball includes roots 26 and potting soil 24. Once the tear strips 20 have been torn from the side wall 14, the root ball with its roots and potting soil is exposed to the soil that is used to fill the planting hole 30 in the ground 28. Consequently, because the plant container 10 is biodegradable in soil, the plant container 10 along with the root ball 36 can be directly placed in the planting hole 30 and covered with soil

In order to enhance the growth of the plant 34 once it has been planted in the ground 28, the roots 26 of the root ball 36 should be teased or otherwise roughened. In order to tease the roots 26 of the root ball 36, the inside surfaces 19 of the tear strips 20 have root slicers 22 that extend into the interior of the biodegradable plant container 10. As the plant 34 grows in the biodegradable plant container 10, the roots 26 of the plant 34 necessarily surround and engage the root slicers 22 on the inside surface 19 of the tear strips 20. As the tear strips 20 are pulled away from the side wall 14 of the plant container 10 prior to planting, the roots slicers 22 cut, pull, and break the roots 26 near the outside of the root ball 36. The root slicers 22 are shown schematically as triangles in FIGS. 2 and 3, but could take any shape that will engage the roots 26 of the plant 34 while the plant is growing in the plant container 10 and any shape that can successfully cut, pull, and break the roots 26 as the tear strips 20 are pulled from the side wall 14 of the plant container 10

In use, the user dislodges the tear strips 20 from the side wall 14 along the tear lines 21 of the plant container 10 and spreads the tear strips 20 as shown in FIGS. 3 and 4. With the tear strips 20 unfolded, the unfolded tear strips 20 defined the proper diameter for the planting hole 30. Likewise, the depth index 32 establishes the proper depth of the planting hole 30 for the user. Moreover, the user does not need to specifically tease the roots 26 of the root ball 36 because pulling the tear strips 20 free from the side wall 14 causes the integral root slicers 22 to sufficiently tease the roots 26. Also, the remaining portions of the side wall 14 tend to hold the root ball 36 from disintegrating while the tear strips 20 are being opened and spread.

In another aspect of the present invention, the plant container 10 can be made of standard nonbiodegradable plastic. Tear strips 20 as previously described have root slicers 22 on the inside surface 19. When the tear strips 20 are pulled open from the top 16, the root slicers 22 tease the roots while the remaining portions of the plant container 10 support the root ball 36 from disintegration. Further, once the tear strips 20 have been opened, the root ball 36 is more easily removed from the plant container 10 than when the side wall 14 of the plant container 10 is fully intact. In connection with the non-biodegradable land container 10, the plastic hinges 23 can be replaced by a tear lines so that the tear strips can be completely removed from the nonbiodegradable plant container 10.

While this invention has been described with reference to preferred embodiments thereof, it is to be understood that variations and modifications can be affected within the spirit and scope of the invention as described herein and as described in the appended claims.

I claim:

1. A biodegradable plant container for planting a plant in a planting hole, the biodegradable plant container comprising:
a. a bottom;
b. a top opening; and
c. a side having a tear strip defined by tear lines extending from the top opening to the bottom.
wherein the plant container is formed of a biodegradable plastic material.

2. The biodegradable plant container of claim 1, wherein the container has planting depth index adjacent the top opening extending around the plant container.

3. The biodegradable plant container of claim 1, wherein the tear strip has a hinge at the bottom of the plant container.

4. The biodegradable plant container of claim 1, wherein the tear strip has a tear line at the bottom of the plant container for removal of the tear strip from the container.

5. The biodegradable plant container of claim 4, wherein the plant container has at least two tear strips that when rotated about the hinge define the diameter of the planting hole.

6. The biodegradable plant container of claim 1, wherein the tear strip has at least one root slicer extending from an inside surface of the tear strip.

7. The biodegradable plant container of claim 1, wherein the biodegradable plastic material is impregnated with beneficial ingredients.

8. The biodegradable plant container of claim 7, wherein the beneficial ingredients include microbes, fertilizers, or pesticides.

9. A plant container comprising:
a. a bottom;
b. a top opening; and
c. a side having a tear strip defined by tear lines extending from the top opening to the bottom.
wherein the tear strip has root slicers extending from an inside surface of the tear strip.

10. The plant container of claim 9, wherein the tear strip has a hinge at the bottom of the plant container.

11. The plant container of claim 9, wherein the tear strip has a tear line at the bottom of the plant container for removal of the tear strips from the plant container.
